(19) United States
(12) Patent Application Publication
(10) Pub. No.: US 2005/0235363 A1
(43) Pub. Date: Oct. 20, 2005

(54) Network, device, and/or user authentication in a secure communication network

(75) Inventors: Richard Hibbard, Bradenton, FL (US); Charlie Lenahan, Dunedin, FL (US)

Correspondence Address: CARLTON FIELDS, P.A., P.O. BOX 3239, TAMPA, FL, 33601-3239, US

(73) Assignee: Fortress Technologies, Inc.

(21) Appl. No.: 11/100,061

(22) Filed: Apr. 6, 2005

Related U.S. Application Data
(60) Provisional application No. 60/559,737, filed on Apr. 6, 2004.

(51) Int. Cl. H04L 9/00

(52) U.S. Cl. 726/28

(57) ABSTRACT

Various embodiments of systems, methods, and computer software for providing a secure access to a communication network are provided. One embodiment comprises a system for providing secure access to a communication network. One such system comprises: a gateway for controlling access to a communication network; and a secure client program executed on a device to access the communication network via the gateway, the secure client program comprising logic configured to: communicate with the gateway via a data link layer; authenticate a network ID with the gateway via the data link layer; authenticate a device ID with the gateway via the data link layer; and authenticate user credentials with the gateway via the data link layer.

### CROSS-REFERENCE TO RELATED APPLICATIONS

This application claims the benefit of U.S. Application Ser. No. 60/559,737, entitled “Method, Apparatus and Computer Software System for Authenticating Users, Hosts and Networks” and filed Apr. 6, 2004, which is hereby incorporated by reference in its entirety.

### BACKGROUND

Devices facilitating direct and remote access to a computer network, including wireless access, are well known in the art. Direct (wired) connectivity to a network provides some security due to the ability to physically secure the physical medium for transmitting information. In contrast, remotely-connected hosts such as hosts connected via a wireless lan, such as IEEE 802.11 or other medium a part of which cannot be physically secured, may pose a greater security risk to the network and its users. Communication between such remotely connected hosts is more susceptible to eavesdropping by a third party.

It is desirable to provide a mechanism to secure communications so that an eavesdropper is less able to intercept or modify their content. It is further desirable that any means for securing permit convenient, efficient and effective system administration without significant impact on performance of the corresponding computer systems. It is also desirable that the security be achieved, so much as possible, with minimum impact on the experience of end-users. Accordingly, a sound, flexibly-administered and secure means for authenticating and thereby securing communications between users, devices and remotely connected network hosts is desired.

These problems have been addressed, in part, by various approaches to authenticate a user onto a network or device. Attempted solutions known in the art include identifying hosts via the host computer's MAC address, perhaps in combination with an authentication server such as a Radius server; smart card authentication using credentials possessed or known to a specific user; and hardware “dongle” technology requiring possession of the dongle and dongle reading device. Such attempted solutions appear to have an unacceptable level of vulnerability, difficulty in deployment, difficulty in use and/or impede the ability of an administrator to conveniently reassign or reconfigure credentials on a by-user or by-device basis.

### SUMMARY

Various embodiments of systems, methods, and computer software for providing a secure access to a communication network are provided. One embodiment comprises a method for providing secure access to a communication network. One such method comprises: providing a device to access a communication network via a gateway; encrypting a network ID associated with the device; providing the encrypted network ID to the gateway using a data link layer packet; decrypting the encrypted network ID at the gateway; authenticating the decrypted network ID as the network ID at the gateway; authenticating the device at the gateway based on a unique device ID associated with the device; and authenticating a user associated with the device at the gateway.

Another embodiment comprises a system for providing secure access to a communication network. One such system comprises: a gateway for controlling access to a communication network; and a secure client program executed on a device to access the communication network via the gateway, the secure client program comprising logic configured to: communicate with the gateway via a data link layer; authenticate a network ID with the gateway via the data link layer; authenticate a device ID with the gateway via the data link layer; and authenticate user credentials with the gateway via the data link layer. Another such system comprises: means for controlling access to a communication network; means for authenticating a network ID associated with a device attempting to access the communication network via a data link layer; means for authenticating a device ID associated with the device via the data link layer; and means for authenticating user credentials associated with a user of the device via the data link layer.

### BRIEF DESCRIPTION OF THE DRAWINGS

A particularly preferred embodiment of the invention will be described in detail below in connection with the drawings in which:

FIG. 1 illustrates an exemplary information technology system with a plurality of components in accordance with one embodiment of the present invention;

FIG. 2 is a schematic diagram of a hardware implementation of one embodiment of the present invention;

FIG. 3 is a schematic representation of a computer network providing for the flow of information between directly and remotely connected hosts in accordance with the present invention;

FIG. 4 is a schematic representation of a method for determining authentication predicates for permitting communications between a user, device and network;

FIG. 5 is a flowchart representation of a method for Network Authentication;

FIG. 6 is a schematic representation of the OSI communications model;

FIG. 7 is a flowchart representation of a method for Device Access Authentication; and

FIG. 8 is a flowchart representation of a method for User Authentication.

### DETAILED DESCRIPTION

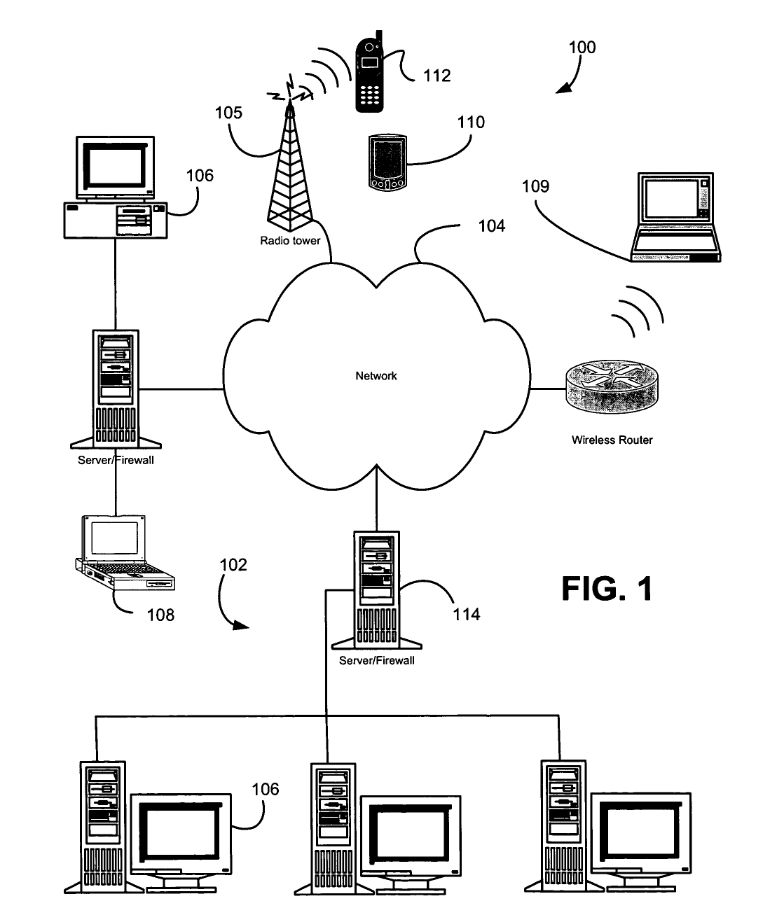

FIG. 1 illustrates an exemplary system 100 with a plurality of components 102 in accordance with one embodiment of the present invention. As shown, such components include a network 104 that takes any form including, but not limited to a local area network, a wide area network such as the Internet, and a wireless network 105. Coupled to the network 104 is a plurality of computers, which may take the form of desktop computers 106, lap-top computers 108, computers connected by wireless lan technology 109, hand-held computers 110 (including wireless devices 112 such as wireless PDA's or mobile phones), or any other type of computing hardware/software. As an option, the various computers may be connected to the network 104 by way of a gateway server appliance 114 that may be equipped with a firewall for security purposes. It should be noted that any other type of hardware or software may be included in the system and be considered a component thereof.

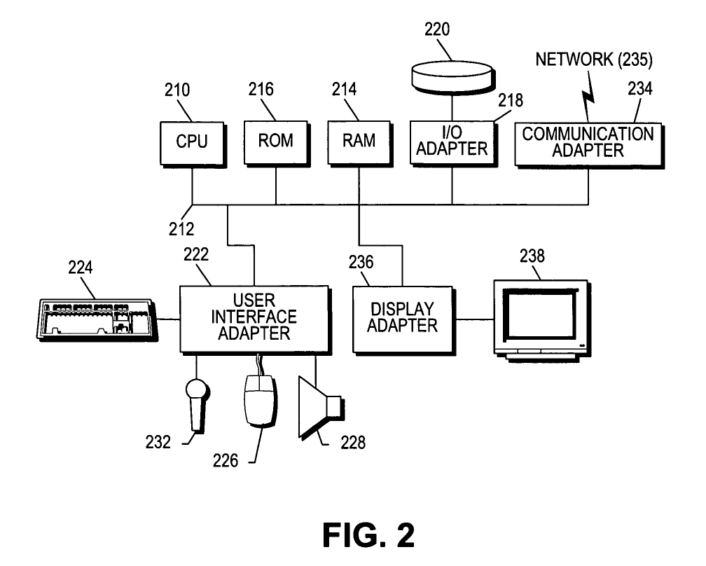

FIG. 2 depicts a representative hardware environment associated with the various components of FIG. 1. In the present description, the various sub-components of each of the components may also be considered components of the system. For example, particular software modules executed on any component of the system may also be considered components of the system. FIG. 2 illustrates a typical hardware configuration of a workstation in accordance with one embodiment having a central processing unit 210, such as a microprocessor, and a number of other units interconnected via a system bus 212. Other components may have some or all of these features.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

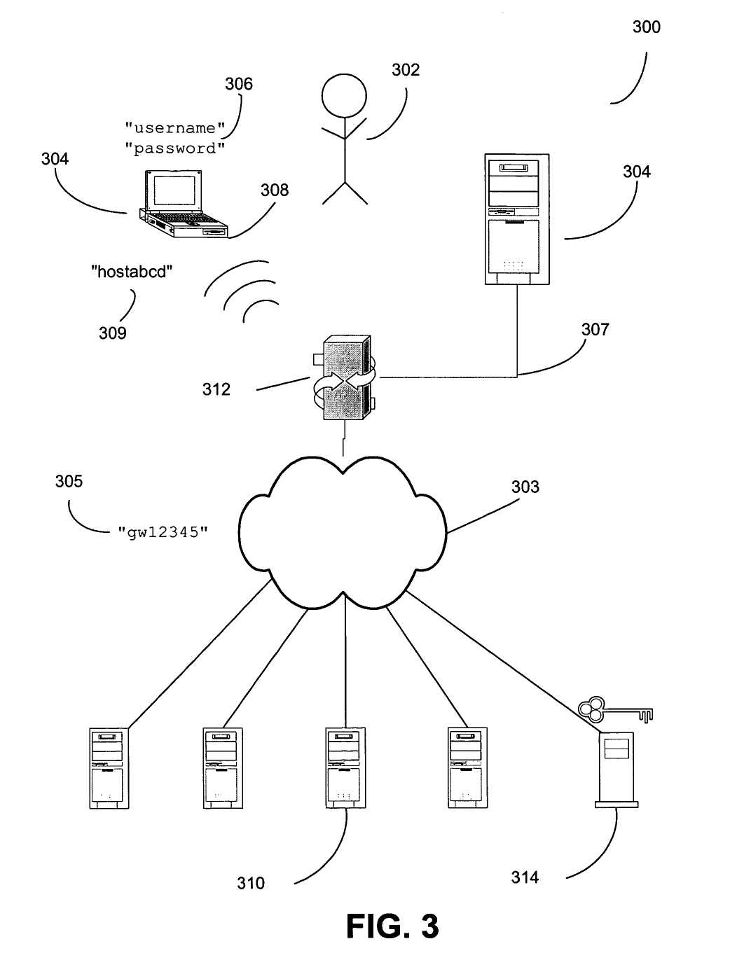

FIG. 3 depicts a secure computing environment 300 of the type that is the subject of this invention. Typically, a user 302 seeks to communicate securely with a network 303 through a specific device 304, conveniently a personal computer. The network may be assigned an access ID (e.g., a secret network ID 305). The user may conveniently be assigned unique network user credentials 306, such as a username and password. The devices 304 may communicate with the network 305 through a variety of media, such as by an Ethernet interface 307, an IEEE 802.11 wireless interface 308 or other means for providing communication among hosts. The device may conveniently be assigned a unique device ID 309. Internal hosts 310 of a network 304, relative to the user 302 may be reached via an authentication gateway 312, which conveniently may be a network appliance such as Fortress Technologies AirFortress gateway.

The gateway 312 may provide principal communications between internal hosts 310 and the user 302, including authentication operations. In an aspect, the network may provide management of authentication by means of an interaction with an independently managed access control server 314, such as a RADIUS or a similar authentication server.

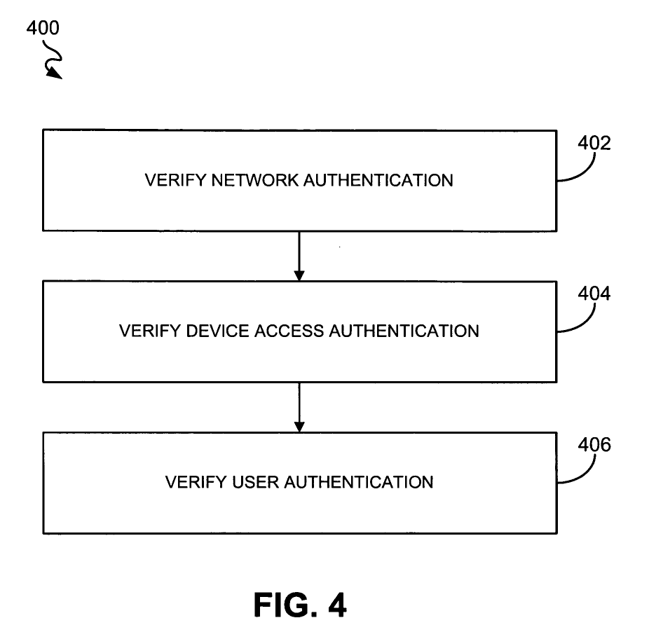

FIG. 4 depicts a method for a flexible and secure predicate 400 to determine when to permit a user 302 and device 304 to intercommunicate with a network 303, through one, two or three phase authentication. Conveniently, and subject to parameters established by a system administrator, access to the network 303 may be selectively granted pending satisfaction of predicates for one, two or all three of the following as defined more particularly herein: Network Authentication 402, Device Authentication 404 and User Authentication 406. Alternatively, access may be selectively blocked if any one, two or all three of the predicates fail.

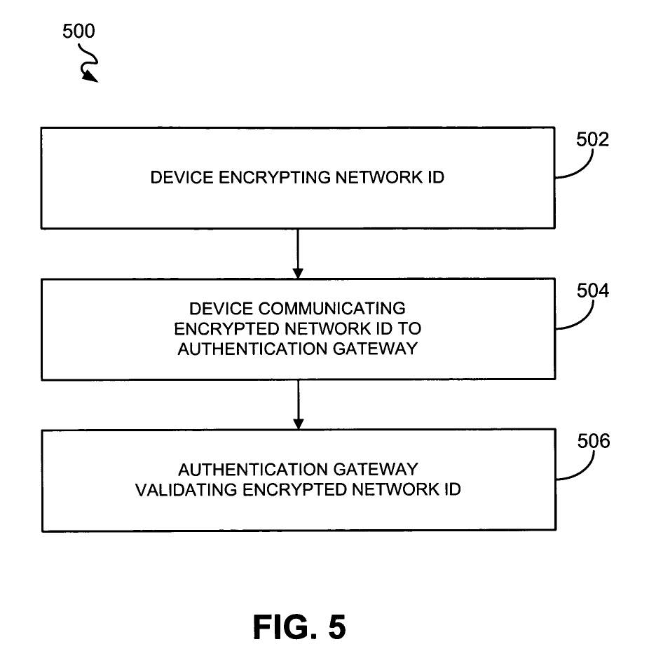

FIG. 5 depicts a method for determining the predicate for Network Authentication 402, 500 between a device 304 and a network 303. The device 304 initiates authentication by encrypting 502 the network ID 305. The device 304 then seeks to initiate access to the network 303 by communicating the encrypted network ID 504 by transmitting data including the encrypted network ID 305 to the authentication gateway 312. The authentication gateway 312 validates the encrypted network access ID 305, and if valid, the predicate for Network Authentication is satisfied 506.

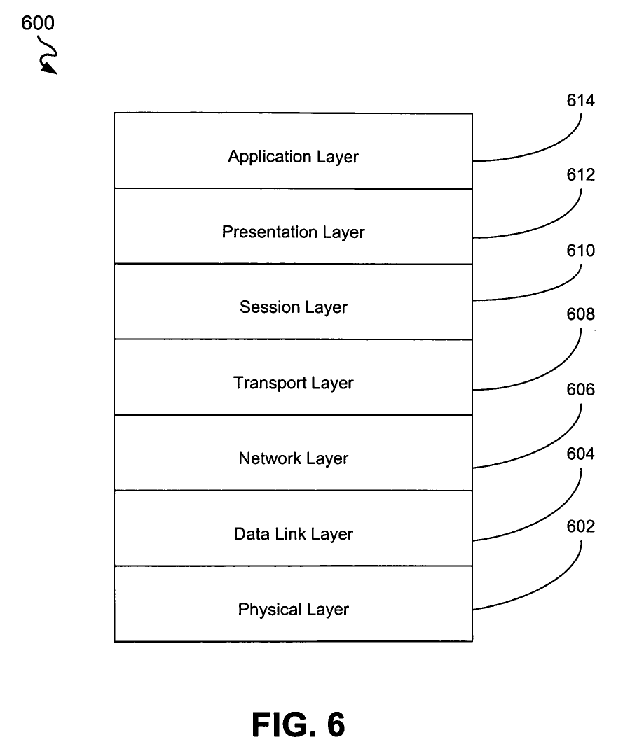

In another aspect, one, two or three of the predicates for authentication are determined at the Data Link layer of the OSI hierarchy. FIG. 6 represents the reference model for Open Systems Communication, or OSI, a standard promulgated by the International Organization for Standardization, also known as the ISO. The OSI standard reference is a high-level architectural model for a software or hardware processes providing communications between two end points. The OSI reference model defines a communication functionality in terms of a linear hierarchy of seven layers 600. Each layer provides services to higher adjacent layers, and is capable of requesting more fundamental services from lower adjacent layers. The seven layers include a first or physical layer 602 which conveys a bit stream through a network at the electrical and mechanical level, providing hardware means for sending and receiving data on a carrier. A second or data link layer 604 traditionally provides functional and procedural means to transfer data between network entities and to detect and possibly correct errors that may occur in the physical layer. A third or network layer 606 handles routing of data, performing routing and forwarding functions. A fourth or transport layer 608 manages end-to-end control of packets and error checking, to ensure complete data transfer. A fifth or session layer 610 sets up, coordinates and terminates communications, exchanges and dialogs between applications at each end, dealing with session and connection coordination. A sixth or presentation layer 612, sometimes called a syntax layer, converts incoming and outgoing data from one presentation format to another. A seventh or application layer 614 identifies communication partners, identifies quality of service, traditionally handles user authentication and privacy considerations and identifies constraints on data syntax. In an aspect, the present invention may incorporate one or more components of user and remote host authentication into levels of the OSI hierarchy below the application layer 614, such as the data link layer 604.

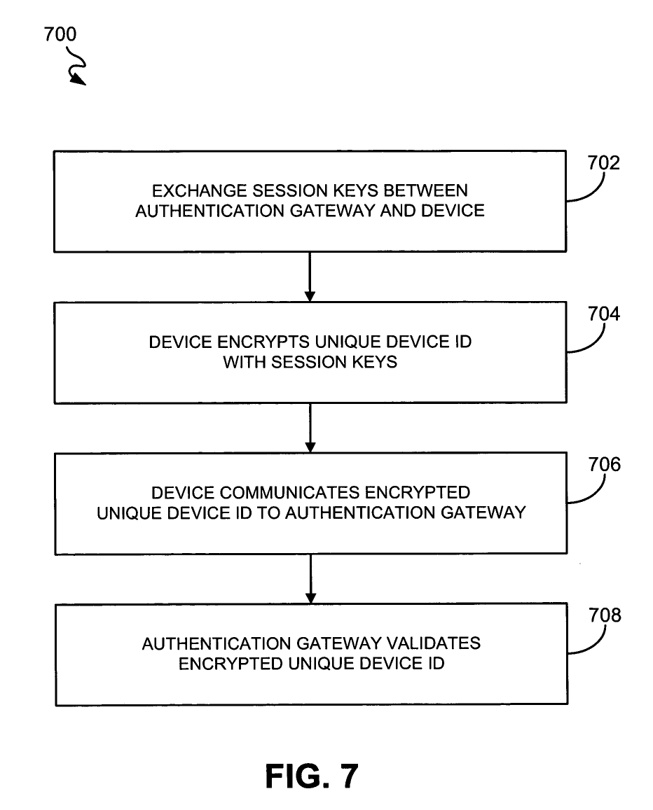

FIG. 7 depicts a method for determining the predicate for Device Access Authentication 404, 700 between a device 304 and a network 303 after the device 304 and network 303 have satisfied the predicate for Network Authentication. After the predicate for Network Authentication is satisfied, the device 304 and authentication gateway 312 exchange 702 session keys, conveniently by means such as a Diffie-Hellman key exchange. The device 304 then encrypts 704 its unique device ID 309. The device 304 then communicates 706 the encrypted unique device ID 309 to the authentication gateway 312. The authentication gateway then validates 708 the encrypted unique device ID 309 to determine whether the predicate for Device Access Authentication is satisfied.

In an aspect, the authentication gateway may communicate with an Access Control Server 314 to determine whether the predicate for Device Authentication is satisfied. Conveniently, the Access Control Server may unconditionally authorize access to the device, conditionally authorize access to the device pending user authentication, conditionally authorize access to the device pending system administrator or other approval of the connection or unconditionally reject access to the device. If the device 304 is unconditionally authorized, then access to the network 303 is allowed. If the device 304 is unconditionally rejected, then access to the network 303 is denied. If authorization is conditioned on a predicate, then further authentication is required.

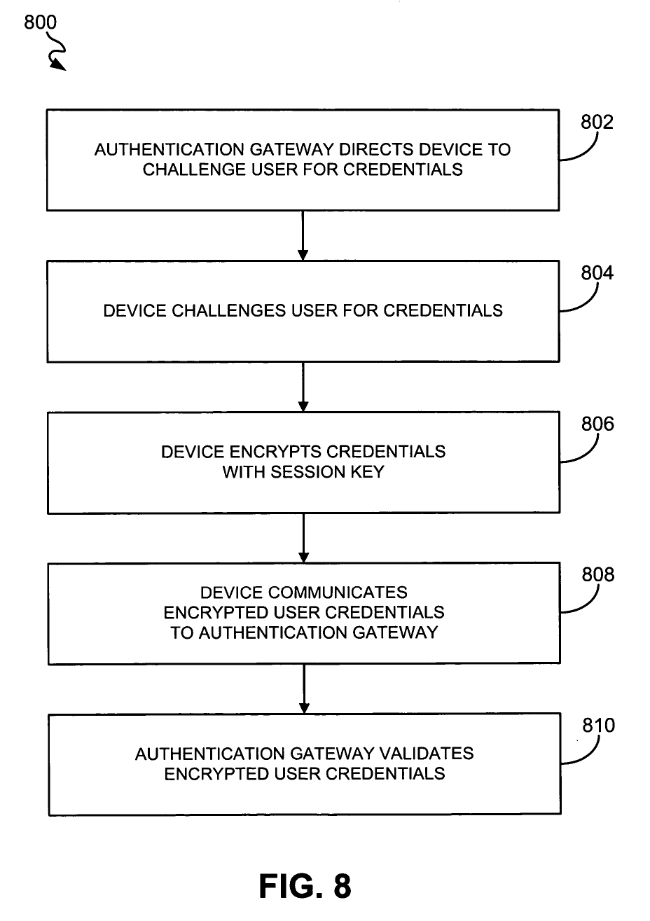

FIG. 8 depicts a method for determining the predicate for User Authentication 406, 800 between a user 302 and a network 303, through a device 304, once the predicate for Device Access Authentication 404 has been satisfied with conditional authorization pending user authentication. The authentication gateway 312 directs 802 the device 304 to challenge user 302 for his user credentials 306, securely communicating the request by use of the session keys established during Device Authentication. The device 304 challenges 804 the user for his user credentials 306, conveniently a user name and password, smart card, or PIN. The device 304 then encrypts 806 the user credentials 306 using the session key established during Device Authentication. The device 304 then transmits 808 the encrypted user credentials 306 to the authentication gateway 312. The authentication gateway then validates the encrypted user credentials 312 to determine whether the predicate for User Authentication 406, 800 is satisfied.

In an aspect, the authentication gateway may communicate with an Access Control Server 314 to determine whether the predicate for User Authentication is satisfied. The Access Control Server authorizes the user to access the network in every case, authorizes the user to access the network only if the user is using an approved device among a list of device IDs, such as device 304, or unconditionally rejects the user. If the user 302 is authorized through the device 304, then access to the network 303 is allowed. If the user 302 is rejected through the device 304, then access to the network 303 is blocked.

One of ordinary skill in the art will appreciate that various aspects of the systems, methods, computer programs, and related equipment described above may be implemented in software, hardware, firmware, or a combination thereof. Accordingly, in one embodiment, at least a portion of the logic and/or functionality associated with the authentication methodologies is implemented in software or firmware that is stored in a memory and that is executed by a suitable instruction execution system or processor. It should be appreciated that various process descriptions, functionality, logic, and services described above represent modules, segments, or portions of code which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, various logical and/or functional aspects of the authentication methodologies described above may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments, particularly any “preferred” or “exemplary” embodiments, are merely possible examples of implementations, merely set forth for a clear understanding of the principles of the invention. Many variations and modifications may be made to the above-described embodiment(s) of the invention without substantially departing from the spirit and principles of the invention. All such modifications and variations are intended to be included within the scope of this disclosure and the present invention and protected by the following claims.

1. A method for providing secure access to a communication network, the method comprising:
providing a device to access a communication network via a gateway;
encrypting a network ID associated with the device;
providing the encrypted network ID to the gateway using a data link layer packet;
decrypting the encrypted network ID at the gateway;
authenticating the decrypted network ID as the network ID at the gateway;
authenticating the device at the gateway based on a unique device ID associated with the device; and
authenticating a user associated with the device at the gateway.

2. The method of claim 1, wherein the device to access the communication network comprises a mobile device.

3. The method of claim 2, wherein the providing the encrypted network ID to the gateway comprises transmitting the encrypted network ID to the gateway using a wireless link layer protocol.

4. The method of claim 1, wherein the authenticating the network ID at the gateway comprises sending an authentication request to an access control server.

5. The method of claim 1, wherein the device communicates with the gateway via at least one of a wireless access point and a wired access point.

6. The method of claim 1, wherein the authenticating the device at the gateway based on a unique device ID associated with the device comprises exchanging a session key between the gateway and the device.

7. The method of claim 6, further comprising:
encrypting the unique device ID with the session key;
providing the encrypted unique device ID to the gateway;
decrypting the encrypted unique device ID at the gateway; and
authenticating the decrypted unique device ID as the unique device ID.

8. The method of claim 7, wherein the providing the encrypted unique device ID to the gateway involves a layer two protocol.

9. The method of claim 1, wherein the authenticating a user associated with the device comprises:
exchanging a session key between the gateway and the device;
sending a request for user credentials from the gateway to the device;
prompting the user for the user credentials;
capturing the user credentials from the user;
encrypting the user credentials with the session key;
providing the encrypted user credentials to the gateway;
decrypting the encrypted user credentials using the session key; and
authenticating the decrypted user credentials as the user credentials.

10. The method of claim 9, wherein the providing the encrypted user credentials occurs via a wireless data layer protocol.

11. The method of claim 10, wherein the authenticating the decrypted user credentials involves an access control server.

12. The method of claim 11, wherein the access control server comprises a stand-alone authentication server.

13. A system for providing secure access to a communication network, the system comprising:
a gateway for controlling access to a communication network; and
a secure client program executed on a device to access the communication network via the gateway, the secure client program comprising logic configured to:
communicate with the gateway via a data link layer;
authenticate a network ID with the gateway via the data link layer;
authenticate a device ID with the gateway via the data link layer; and
authenticate user credentials with the gateway via the data link layer.

14. The system of claim 13, further comprising an access control server in communication with the gateway, the access control server configured to assist the gateway in at least one of the network ID authentication, the device ID authentication, and the user credentials authentication.

15. The system of claim 14, wherein the access control server performs a proxy to a stand-alone server for at least one of the network ID authentication, the device ID authentication, and the user credentials authentication.

16. The system of claim 13, wherein the secure client program comprises logic configured to exchange a session key with the gateway, and the session key is used to employ an encryption scheme between the device and the gateway.

17. The system of claim 13, wherein the logic configured to authenticate the network ID comprises logic configured to encrypt the network ID with a session key, and the gateway decrypts the encrypted network ID with the session key.

18. The system of claim 13, wherein:
the logic configured to authenticate the device ID with the gateway comprises logic configured to encrypt the device ID with a session key, and the gateway decrypts the encrypted device ID with the session key; and
the logic configured to authenticate the user credentials comprises:
logic configured to receive a request for the user credentials from the gateway;
logic configured to prompt the user for the user credentials;
logic configured to capture the user credentials from the user;
logic configured to encrypt the user credentials with the session key; and
logic configured to provide the encrypted user credentials to the gateway.

19. The system of claim 13, wherein the device comprises a mobile device, and the secure client program supports a plurality of hardware and software platforms.

20. A system for providing secure access to a communication network, the system comprising:
means for controlling access to a communication network;
means for authenticating a network ID associated with a device attempting to access the communication network via a data link layer;
means for authenticating a device ID associated with the device via the data link layer; and
means for authenticating user credentials associated with a user of the device via the data link layer.
